(19) United States
(12) Patent Application Publication
(10) Pub. No.: US 2006/0048403 A1
(43) Pub. Date: Mar. 9, 2006

(54) Window tint apparatus with an apparatus or template to give size and shape, allow for securing material and make cut-to-size materials to tint windows

(76) Inventor: Christopher C. Brister, Zanesville, OH (US)

Correspondence Address: Christopher Charles Brister, 428 Warwick Ave., Zanesville, OH, 43701, US

(21) Appl. No.: 10/934,024

(22) Filed: Sep. 3, 2004

(51) Int. Cl. G01B 3/14

(52) U.S. Cl. 33/566

(57) ABSTRACT

The window tinting template is a flexible plastic, polymer, or similar material with window geometries drawn or carved on, or in to one surface and is used to secure the tinting film and provide a guide for accurate cutting of the tinting material. The geometries exceed slightly the actual exposed window size to permit complete tinting at all edges of the window frame. The template is used for opposing windows by flipping the film and repeating the procedures. The film is temporally secured to the template using water, soap and water, or other temporary adhesive. After cutting, the tint is applied by hand with or without the aid of a squeegee or similar tool.

### EXPLANATION OF DRAWINGS

FIG. 1 Pre-sized template or apparatus based on manufacturer or other design and specifications.

FIG. 2 Film or other material sized to measurements that exceed the geometry of the template.

FIG. 3 Film, template with temporary adhesive (soap, water, and/or water or other solution) to secure film to template for cutting

FIG. 4 Film or other material cut to size of factory or other specifications

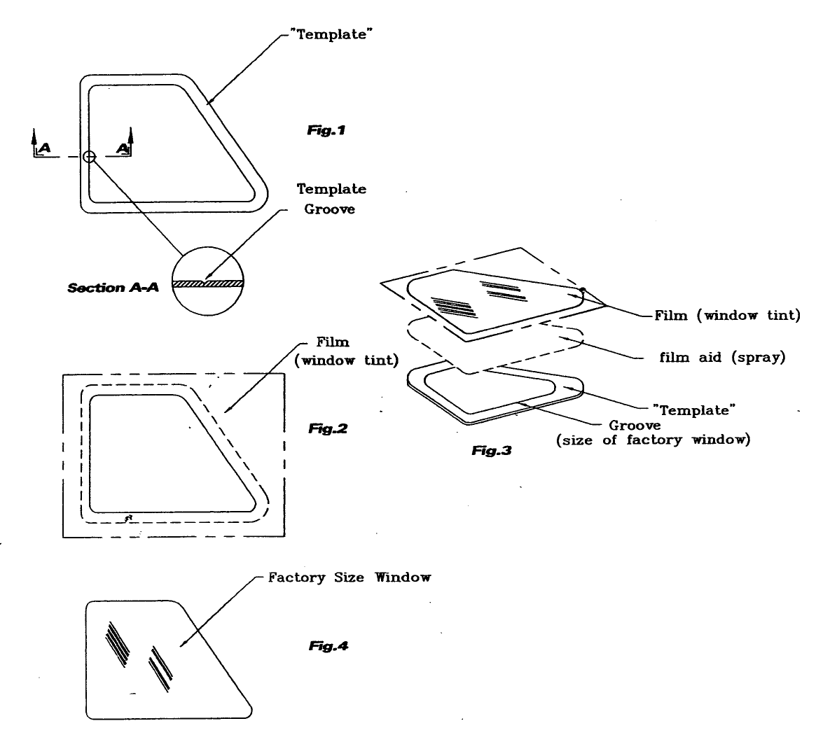

Film or other material cut to size of factory or other specifications

I claim that:

1. A template, securing and cutting system for use in window tinting is superior to and different than existing methods.

2. The system reduces errors and costs by eliminating mis-cuts, allows for cuts of opposing windows, matches any geometry and improves an existing window tint patents.
Ref.
2698753
2780458
3868293
4331359
4409858
4592180
4692180
4653797
4930255
4943103
